(19) United States
(12) Patent Application Publication
(10) Pub. No.: US 2009/0014510 A1
(43) Pub. Date: Jan. 15, 2009

(54) RETAIL CASH DRAWER CHANGE HELPER WITH ERROR CORRECTION ENHANCEMENTS

(75) Inventors: Aaron R. Cox, Tucson, AZ (US); Thomas J. Sluchak, Apex, NC (US); Ronald A. Smith, Wake Forest, NC (US); Robert P. Tennant, Raleigh, NC (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/774,673

(22) Filed: Jul. 9, 2007

(51) Int. Cl. G07G 1/06

(52) U.S. Cl. 235/23; 194/215; 235/7 A; 705/16

(57) ABSTRACT

A cash register including a cash drawer having currency compartments, each currency compartment including a currency signaling device for signaling to the cash register a quantity of currency in the respective currency compartment; and at least one display for indicating a quantity of currency to be dispensed from each currency compartment.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to the field of retail cash registers and point of sale.

2. Description of the Related Art

Cash registers are generally used to record sales transactions and hold currency. Typically, a cashier who works for a company selling a product operates the cash register. During a sales transaction, the cashier enters the items sold either manually by pressing keys or automatically such as with an optical or non-optical scanner. When all the sales items for a customer are recorded, the cash register will add the sales item prices, calculate any sales tax if applicable, and display a total amount due. After the total amount due is displayed, the cashier can accept payment from the customer. If the customer is paying with cash, the cashier will accept the cash and key enter into the cash register the amount tendered by the customer. The cash register will display an amount of change due to the customer and a cash drawer will usually open. The cashier will complete the transaction by providing the amount of change to the customer. Cash transactions are usually performed using the cash drawer.

The cash drawer is typically part of the cash register although the cash drawer may sometimes be located separately from a section of the cash register having a display and input devices. The cash drawer generally has separate currency compartments for each denomination of currency. For example, in the United States, for paper currency, there are currency compartments for one-dollar bills, five-dollar bills, and so on. Similarly for coins, there are currency compartments for pennies, nickels, dimes and etc. For other countries and regions of the world, cash drawers have similar bill and coin compartments to accommodate the country or region-specific currency.

The cashiers are responsible for sorting and placing cash received from the customer into appropriate currency compartments. Also, the cashiers are responsible for making change by removing currency from the appropriate currency compartments. The cashier typically may use his or her discretion for determining which denominations to use for making the change.

Retail cashiers can be in limited supply in certain cities and geographies. Consequently, retailers may hire some individuals with limited mathematics skills to work as cashiers. For cashiers with limited math skills malting change can be a challenge. Some of the cashiers may not be able to count well.

If the cashier cannot count well, mistakes can be made in removing currency from the cash drawer to make change. If too much change is mistakenly dispensed, the retailer will lose money. If too little change is dispensed, a customer will be shortchanged and may choose not to shop with this retailer in the future. Other problems may result from the cashier using his or her discretion when making change. For example, if the cashier does not select coins and bills in a fashion that uses the least number from each currency compartment, time is wasted making change. A delay will unnecessarily add to transaction time, possibly upsetting the customer being served and those waiting in a queue. For another example, the cashier may dispense all the currency of a particular denomination. With all the currency of a particular denomination gone, the cashier may be confused with making change with the remainder of the denominations. Further, with all of the pennies gone, the cashier will not be able to make change to the cent. Another delay will result from waiting for a replenishment of currency.

In retrieving currency of a given denomination from the associated currency compartment, cashiers are required to mentally total the cumulative value of the currency pulled from each currency compartment as well as the overall total pulled from all of the currency compartments collectively. An improvement, suggested in prior art, is to have the cash register recommend the number of currency units, bills or coins, to be pulled from each currency compartment. The cashier then can pull the recommended number of currency units from each currency compartment without being required to mentally total the value of the currency pulled from the currency compartments individually or collectively.

To help cashiers select appropriate currency in an efficient manner, prior art described algorithms or calculation methods for determining the least number of bill or coin pulls to total a given amount. Previously proposed ideas typically used displays or indicators to inform the cashier what coin or bill quantity to withdraw from the cash drawer. However, the displays do not take into account quantities of denominations of currency available in the cash drawer. Sensors have been used to detect an amount of coins and bills present in each currency compartment. The sensors, however, have not been used as input to the algorithms or calculation methods for making change.

Therefore, what are needed are an apparatus and method for the cashier to accurately and quickly make change.

### SUMMARY OF THE INVENTION

The shortcomings of the prior art are overcome and additional advantages are provided through the provision of a cash register including a cash drawer having currency compartments, each currency compartment including a currency signaling device for signaling to the cash register a quantity of currency in the respective currency compartment; and at least one display for indicating a quantity of currency to be dispensed from each currency compartment.

Also disclosed is a computer program product stored on machine-readable media, the product including instructions for operating a cash register having a cash drawer, the cash drawer having currency compartments, the product including instructions for calculating a total amount due a customer as change; receiving information related to a quantity of currency in each currency compartment; and displaying on a plurality of displays a number of currency units from each currency compartment to be dispensed to the customer as the change, wherein the number is less than or equal to the quantity in each respective currency compartment, wherein the sum of the numbers is the smallest to provide the change, and wherein each display in the plurality of displays provides the number for the respective currency compartment.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution for a cashier to accurately and quickly make change through the provision of a computer program product stored on machine-readable media, the product including instructions for operating a cash register having a cash drawer, the cash drawer having currency compartments, the product including instructions for calculating a total amount due a customer as change; receiving information related to a quantity of currency in each currency compartment; and displaying on a plurality of displays a number of currency units from each currency compartment to be dispensed to the customer as the change, wherein the number is less than or equal to the quantity in each respective currency compartment, wherein the sum of the numbers is the smallest to provide the change, and wherein each display in the plurality of displays provides the number for the respective currency compartment.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary embodiment of a cash register;

FIG. 2 illustrates an exemplary embodiment of a cash drawer with a display and a push-button for each currency compartment;

FIG. 3 illustrates an exemplary embodiment of the cash drawer with the display indicating denomination removal for $90.85 in change; and

FIG. 4 presents an exemplary method for operating the cash register with a currency signaling device and a change display.

The detailed description explains the preferred embodiments of the invention, together with advantages and features, by way of example with reference to the drawings.

### DETAILED DESCRIPTION OF THE INVENTION

The teachings provide a cash register that recognizes when at least one of a low and a zero quantity of currency exists in each currency compartment of a cash drawer. The cash register displays a quantity of each denomination of currency to be dispensed to a customer as change accounting for the at least one of a low and a zero quantity of a denomination of currency. Further, a signal, alerting of the at least one of a low and a zero quantity of a denomination of currency, can be transmitted to a location remote from the cash register. The location upon receiving the signal can dispatch someone to re-supply currency to the cash register sending the signal.

Typically, the cash drawer is part of the cash register. The cash drawer has separate compartments referred to as “currency compartments.” One currency compartment contains one denomination of currency. The cash register is electrically operated and uses electronics for performing calculations.

The cash register includes a currency signaling device for signaling a quantity of currency in each currency compartment. The currency signaling device typically weighs the currency in the currency compartment although alternate ways are available. The currency signaling device can also be manually operated by a cashier. In one exemplary embodiment, the device can be a push-button. The push-button can be used to send a signal to the cash register that a currency compartment has at least one of a low and zero quantity of currency. In another exemplary embodiment, more than one device may be associated with each currency compartment such as a weight sensor and the push-button. Using the signal, the cash register determines the quantity of denominations to be dispensed to the customer as change. If one currency compartment is at least one of low and empty, the cash register can compensate by indicating an increased quantity of lower denominations to be provided to the customer.

The cash register also includes at least one change display indicating the quantity of each denomination to be dispensed to the customer as change. The quantity of each denomination is typically determined to provide a least number of withdrawals of currency from the cash drawer based on the quantity currency in each currency compartment.

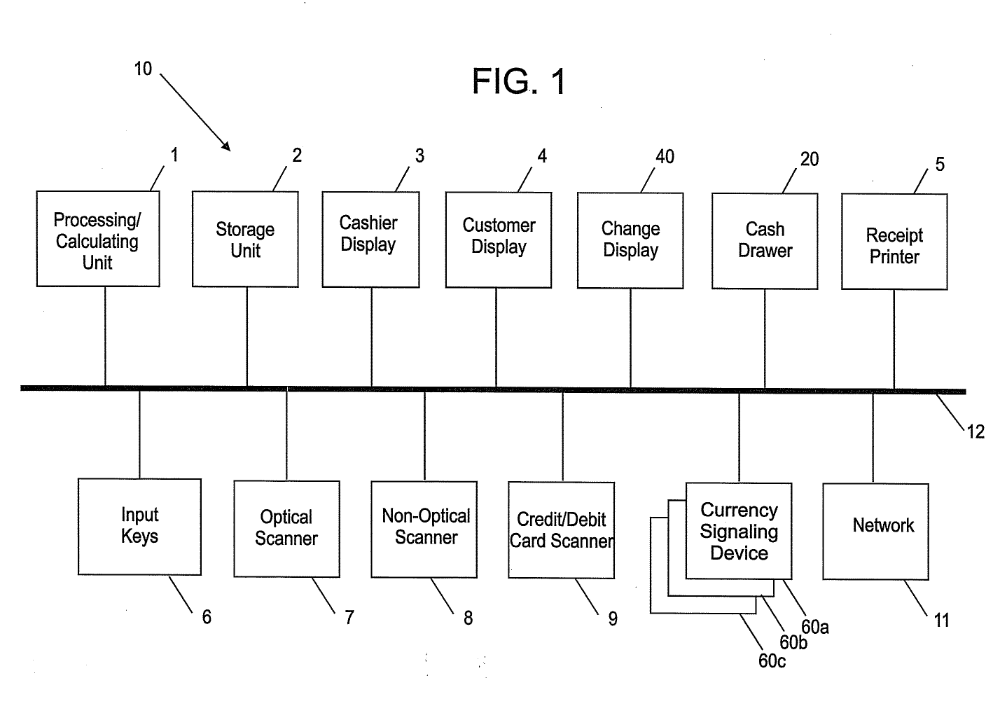

Referring now to FIG. 1, an exemplary embodiment of a cash register 10 for implementing the teachings herein is depicted. The cash register 10 includes a processing/calculating unit 1. The calculating unit 1 calculates the least number of withdrawals or pulls of currency from the cash drawer based on the quantity of currency in each currency compartment. The calculating unit 1 is coupled to storage 2 and various other components via a bus 12. The storage 2 can read machine-readable media and store a computer program for operating the cash register 10. The calculating unit 1 can execute the instructions of the computer program. The cash register 10 includes a cash drawer 20 also connected to the bus 12. The bus 12 also provides for communicating with a network 11. The network 11 can provide for alerting the remote location of the at least one of a low and a zero quantity of a denomination of currency. Not depicted but provided are any interface units or adapters required to couple any components or networks to the bus 12.

FIG. 1 further depicts a cashier display 3 and a customer display 4. Also shown connected to the bus 12 is a change display 40 used to indicate the number of bills or coins in each currency compartment to be provided to the customer as change. The cash register 10 can include more than one change display 40. The change display 40 typically receives information from the calculating unit 1. A receipt printer 5 provides for printing a receipt for a customer making a purchase. The cash register 10 includes input devices such as input keys 6, optical scanner 7, non-optical scanner 8, and credit/debit card scanner 9. The cash register 10 also includes currency signaling devices 60a, 60b, 60c, etc. (collectively referred to as currency signaling devices 60). At least one currency signaling device 60 is associated with each currency compartment.

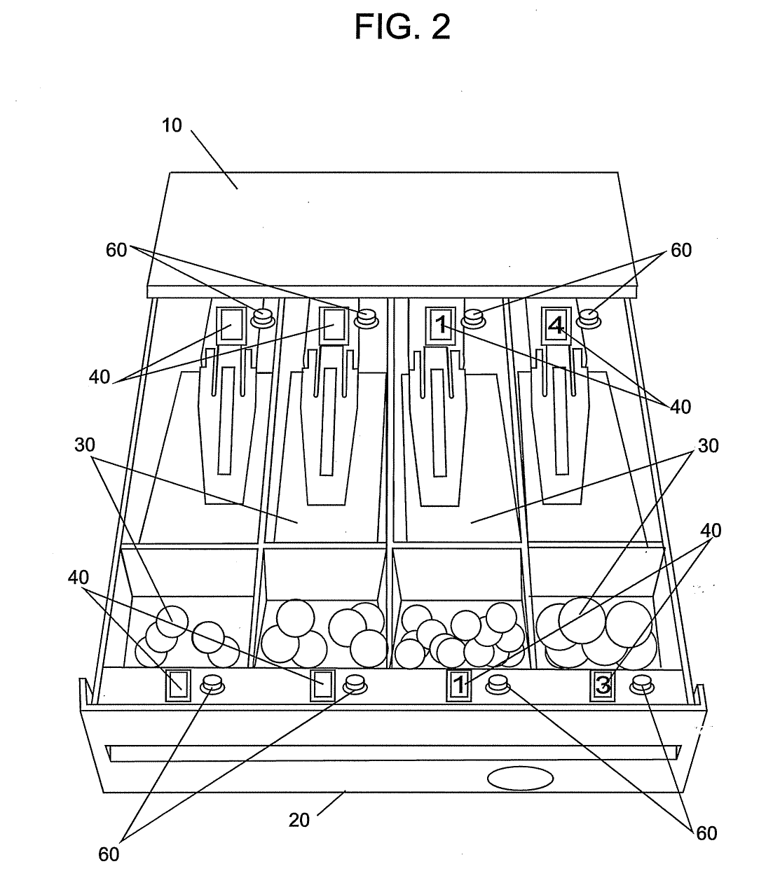

FIG. 2 illustrates an exemplary embodiment of the cash register 10. Referring to FIG. 1, the cash register 10 includes the cash drawer 20. FIG. 1 illustrates the cash drawer 20 in an open position. The cash drawer 20 includes one currency compartment 30 for each denomination of currency. For teaching purposes, the embodiment of FIG. 1 includes eight currency compartments 30. The teachings provide for a cash drawer 20 with any number of currency compartments 30. In the embodiment of FIG. 2, a display 40 is disposed in proximity to each currency compartment 30. The display 40 is located to minimize interference withdrawal of currency and to maximize legibility. In other embodiments, the display 40 can be disposed remote to the cash drawer 20 such as near the input keys 6 for example. The display 40 illustrated in FIG. 2 is a single digit display. The display 40 can be one or more digits. Exemplary embodiments of the display 40 include light-emitting diodes, organic light-emitting diodes, a liquid crystal display, and an electronic ink display.

Referring to FIG. 2, the cash register 10 includes one currency signaling device 60 associated with each currency compartment 30. The currency signaling device 60 provides a signal corresponding to a quantity of currency in the respective currency compartment 30. The signal is typically sent to the calculating unit 1. In the embodiment of FIG. 2, the currency signaling device 60 provides for sending a signal that the currency compartment 30 is at least one of low and empty. In other embodiments, the currency signaling device 60 can measure a quantity of currency in the currency compartment 30. When the currency signaling device 60 measures the quantity of currency in the currency compartment 30, the calculating unit 1 will determine if the currency compartment 30 is at least one of low and empty. Returning to the embodiment of FIG. 1, the currency detecting signaling device 60 is a push-button (referred to as push-button 60). The currency signaling device 60 is located to minimize interference with drawal of currency. Exemplary embodiments of the currency signaling device 60 include a load cell, a photo-sensor, an inductive proximity sensor, and a push-button.

An example of operation of the teachings is now provided. Consider a customer making a purchase that totals $8.15. The customer tenders to a cashier a one hundred-dollar bill. The cashier enters $100.00 into the cash register 10 as an amount tendered by the customer. The cash register 10 determines change due to the customer and displays $90.85 as the change due. The cashier has a wide variety of coin and bill combinations that can be withdrawn from the cash drawer 20. However, the most efficient actions are to withdraw bills and coins as follows: four twenty-dollar bills, one ten-dollar bill, three quarters, and one dime. Referring to FIG. 2, the displays 40 indicate the most efficient withdrawal of bills and coins. However, note that the currency compartment 30 for ten-dollar bills and the currency compartment 30 for dimes are empty. The cashier can press the push-buttons 60 associated with currency compartments 30 that are empty.

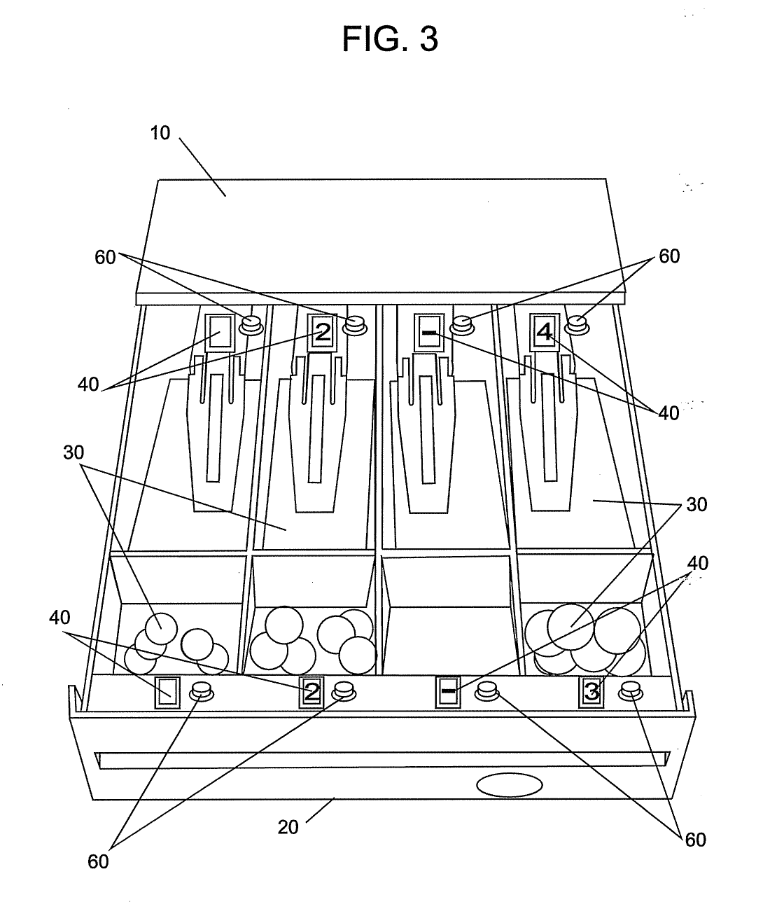

Pressing the push-buttons 60 signals the cash register 10 of the currency compartments 30 that are at least one of low and empty. The cash register 10 will re-compute the quantity of currency to be dispensed from each currency compartment 30 compensating for the lack of ten-dollar bills and dimes. Referring to FIG. 3, the displays 40 indicate a new quantity of currency to be dispensed from each currency compartment 30. The displays 40 indicate the new quantity of currency to be dispensed as follows: four twenty-dollar bills, two five-dollar bills, three quarters, and two nickels. The total amount of the change is the same, $90.85, but the quantities of some denominations are different. The displays 40 indicating a “-” (dash) as shown in FIG. 3 signify that the associated currency compartment 30 is empty.

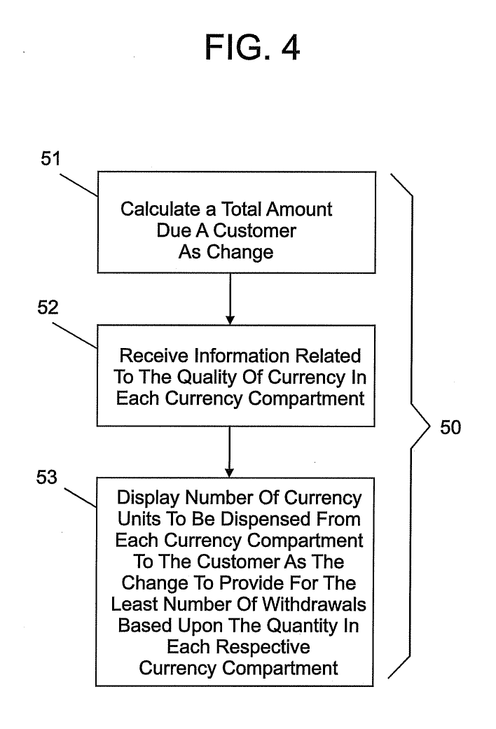

An exemplary method 50 is presented in FIG. 4 for operating the cash register 10 with the currency signaling devices 60 and the display 40. A first step 51 calls for calculating a total amount due a customer as change. A second step 52 calls for receiving information related to the quantity of currency in each currency compartment. A third step 53 calls for displaying a number of currency units from each currency compartment to be dispensed to the customer as the change. In accordance with the teachings herein, the number is less than or equal to the quantity of currency in each respective currency compartment. Also in accordance with the teachings herein, the number displayed for each respective currency compartment provides for a least number of withdrawals.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A cash register comprising:
a cash drawer comprising currency compartments, each currency compartment comprising a currency signaling device for signaling to the cash register a quantity of currency in the respective currency compartment; and
at least one display for indicating a quantity of currency to be dispensed from each currency compartment.

2. The register as in claim 1, wherein the currency detector comprises at least one of a load cell, a photo sensor, an inductive proximity sensor, and a push-button.

3. The register as in claim 1, wherein the display comprises at least one of light-emitting diodes, organic light-emitting diodes, a liquid crystal display, and an electronic ink display.

4. The register as in claim 1, wherein the quantity comprises a least amount to provide change.

5. The register as in claim 1, further comprising an output signal for alerting a remote device that at least one currency compartment is at least one of low and empty.

6. A computer program product stored on machine-readable media, the product comprising instructions for operating a cash register comprising a cash drawer, the cash drawer comprising a plurality of currency compartments, the product comprising instructions for:
calculating a total amount due a customer as change;
receiving information related to a quantity of currency in each currency compartment; and
displaying on a plurality of displays a number of currency units from each currency compartment to be dispensed to the customer as the change, wherein the number is one of less than and equal to the quantity in each respective currency compartment, wherein the sum of the numbers is the smallest to provide the change, and wherein each display in the plurality of displays provides the number for the respective currency compartment.
